(19) United States
(12) Patent Application Publication
(10) Pub. No.: US 2016/0349944 A1
(43) Pub. Date: Dec. 1, 2016

(54) DYNAMIC TIDY CORRELATED ICON DEPENDING ON THE FAVORITE

(71) Applicant: International Business Machines Corporation, Armonk, NY (US)

(72) Inventors: Hao Feng, Beijing (CN); Shuo Li, Beijing (CN); Shengyan Sun, Beijing (CN)

(21) Appl. No.: 15/051,720

(22) Filed: Feb. 24, 2016

Related U.S. Application Data
(63) Continuation of application No. 14/726,659, filed on Jun. 1, 2015.

(51) Int. Cl. G06F 3/0482; G06F 3/0481

(52) U.S. Cl. CPC G06F 3/0482; G06F 3/04817

(57) ABSTRACT

A computer-implemented method for displaying icons on a computing device are provided. The computer-implemented method for displaying icons on a computing device includes exiting a target application; determining if a floating list exists relating to the target application; displaying the floating list in a descending order of likelihood values if a floating list exists; identifying applications used after exiting the target application; assigning likelihood values to the applications used after exiting the target application, where the likelihood values depend on at least the number of intervening applications opened between the application and the target application; and updating the floating list to include the applications with likelihood values used after exiting the target application.

### BACKGROUND

The present invention relates generally to the field of mobile electronic devices, and more particularly to systems and methods for displaying icons and managing application on mobile devices.

Mobile electronic communication devices have evolved beyond simple telephone functionality and are now highly complex multifunctional devices with capabilities approaching desktop or laptop computers. In addition to voice communications, many mobile communication devices are capable of text messaging, e-mail communications, Internet access, and running full-featured application software. Smartphones and similar advanced mobile devices typically run a mobile operating system (e.g., Android, iOS, etc) to manage communication functions and execute applications (‘apps’) that are installed on the device. As the power of these devices increases, so too does the number of apps that can be installed and run to the point that smartphones and tablet computers are rapidly becoming the principal computing device for many people. Greater reliance on mobile devices has consequently placed a great deal of emphasis on the display and graphical user interface (GUI) aspects of these devices, as touchscreen displays have increasingly come to replace the familiar numeric or QWERTY keyboard as the primary interface. A universal constraint facing smartphones and smaller tablet computers, however, is the physical limitation of the display size. No matter how powerful or sophisticated a smartphone or other mobile device may become, it is practically limited to a relatively small display size due to the need to keep it hand-held and portable.

In the face of the display size constraint, the ever-increasing number of applications available for installation on mobile devices has necessitated the need to manage the graphical presentation and management of all of the visual elements that can be displayed through the display. Applications and other device functions are typically represented as icons on the display screen, and a typical user may have dozens of applications that he or she uses on a regular or semi-regular basis. However, since the display area on a mobile device is typically limited to 3-5 inches, a large number of icons can quickly clutter a screen or require scrolling or switching of screens to view all of the available icons. This can limit the usability of the interface and cause a great deal of user frustration.

Although certain user interface methods are presently available to help users organize or simplify their device home screens, these methods typically require a great deal of manual input by the user to create folders or containers and move icons around in a desired organizational structure. Other systems may allow for the automatic selection of home screens that have been pre-configured by the user. However, these systems also generally require a high degree of user input or configuration, and do not provide full automation of tasks associated with displaying and organizing application icons for efficient display and effective interface strategies.

### SUMMARY

According to one embodiment of the present invention, a computer-implemented method for displaying icons on a computing device is provided. The computer-implemented method includes exiting a target application; determining if a floating list exists relating to the target application; displaying the floating list in a descending order of likelihood values if a floating list exists; identifying applications used after exiting the target application; assigning likelihood values to the applications used after exiting the target application, where the likelihood values depend on at least the number of intervening applications opened between the application and the target application; and updating the floating list to include the applications with likelihood values used after exiting the target application.

### BRIEF DESCRIPTION OF THE DRAWINGS

Novel characteristics of the invention are set forth in the appended claims. The invention will best be understood by reference to the following detailed description of the invention when read in conjunction with the accompanying figures, wherein like reference numerals indicate like components, and:

FIG. 1 illustrates a networked computer environment, according to an embodiment;

FIG. 2 illustrates an operational flowchart depicting the steps carried out by a program for displaying icons on a computing device, according to an embodiment;

FIG. 3 illustrates a user interface on a computing device, according to an embodiment;

FIG. 4 illustrates a floating list displayed on the user interface of the computing device, according to an embodiment;

FIG. 5 illustrates a block diagram of internal and external components of computers and servers depicted in FIG. 1, according to an embodiment;

FIG. 6 illustrates a cloud computing environment including a computer system depicted in FIG. 1, according to an embodiment; and

FIG. 7 illustrates a block diagram of functional layers of the illustrated cloud computing environment of FIG. 6, according to an embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

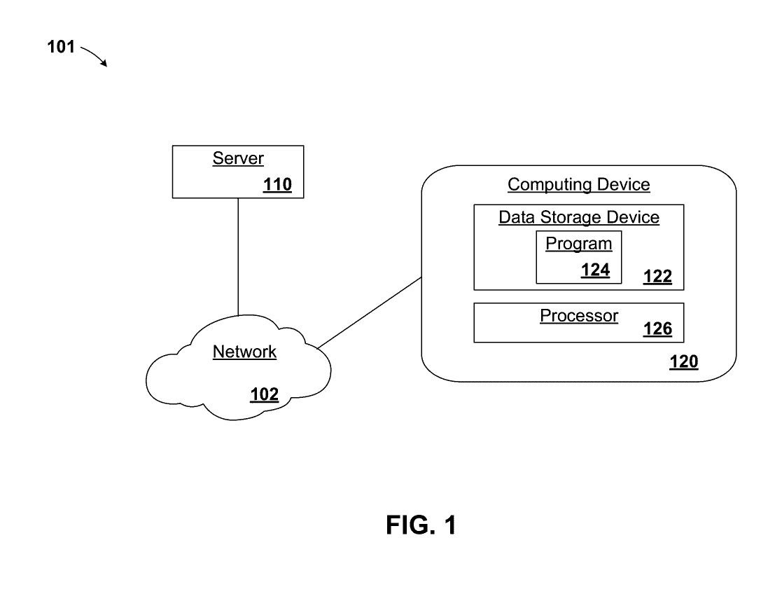

An embodiment of the present invention will now be described in detail with reference to FIGS. 1-7. Referring to FIG. 1, a computer network environment 101 that supports mobile communication devices and other network elements is illustrated. The computer network environment 101 may include a plurality of computing devices 120 and servers 110, only one of which is shown. The computer network environment 101 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

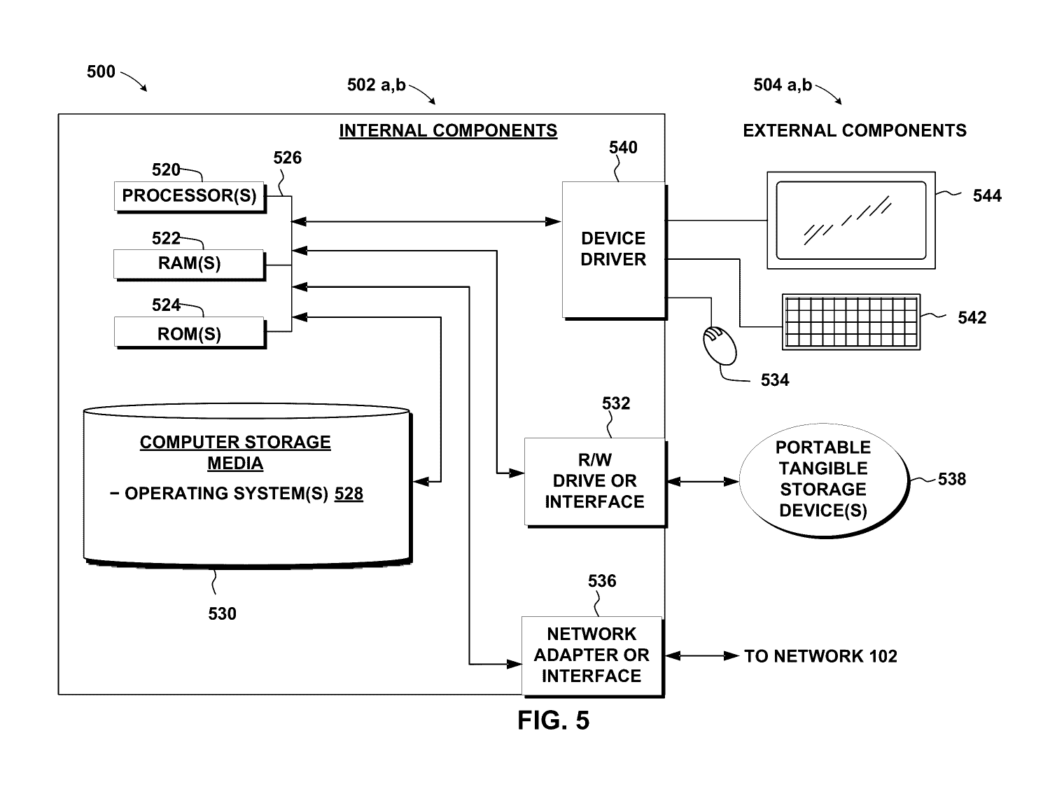

The computing device 120 may communicate with the server 110 via the communications network 102. The communications network 102 may include connections, such as wire, wireless communication links, or fiber optic cables. As will be discussed with reference to FIG. 5, server 110 may include internal components 502a and external components 504a, respectively, and computing device 120 may include internal components 502b and external components 504b, respectively.

Computing device 120 may be, for example, a mobile device, a telephone, a personal digital assistant, a netbook, a laptop computer, a tablet computer, a desktop computer, or any type of computing devices capable of running a program and accessing a network. The computing device 120 has a processor 126 and a data storage device 122 that is enabled to run a software program 124.

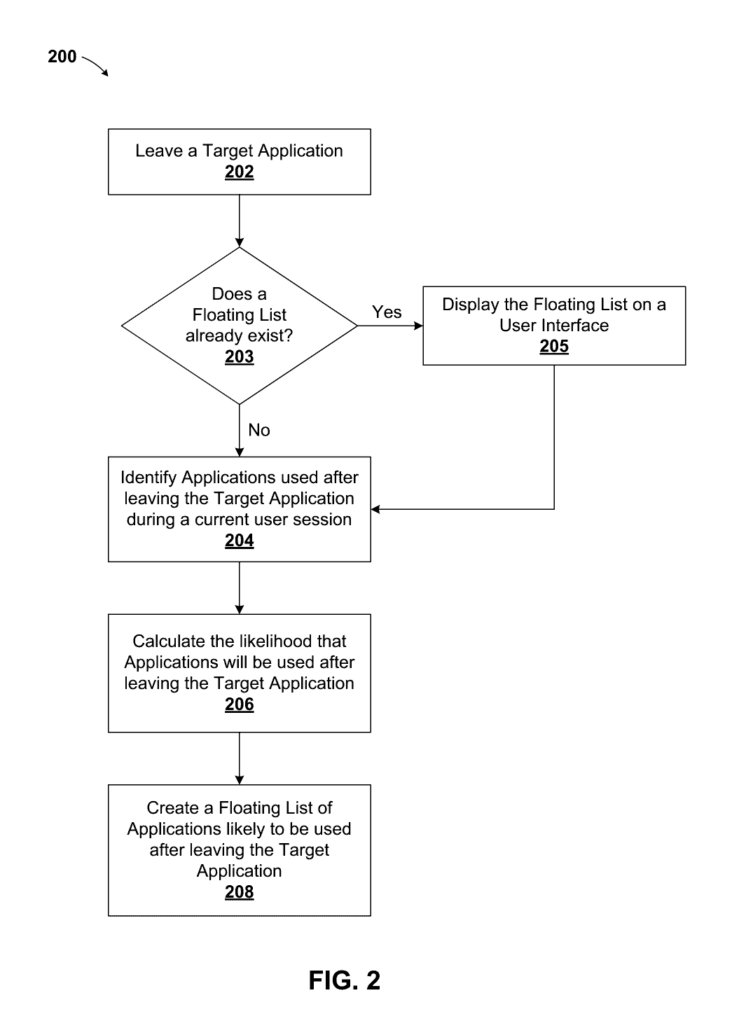

Referring now to FIG. 2, an operational flowchart 200 depicts steps carried out by a program (e.g., program 124 described with reference to FIG. 1) to create a dynamic floating list for a target application. More specifically, the floating list can include applications that are likely to be used after leaving the target application.

In an embodiment, a mobile device is the computing device used by a user. The mobile device can have large numbers of applications installed or running on the mobile device at any given time. Each application icon may be set at a single location on a user interface, such that, the application icons span across multiple user screens.

During a user session, applications may be opened and closed in a seemingly random order, such as, for example, a user may open a target application x-number of times in a given week and y-number of times the following week, where [x≠y]. Furthermore, applications opened after the target application from session to session may also vary, such that, for example, a secondary application may be opened after the target application on a given day and not opened after the target application the following day. Moreover, the number of intervening applications opened between the target application and the secondary application may also vary. In an embodiment of the present invention, a floating list can be created to display applications likely to be used after closing a target application. It should be noted, the “target application” can be any application on a computing device and the “secondary applications” can be any other applications on the computing device. Additionally, a “secondary application” may be referred to simply as an “application” in relating the secondary application to the target application.

The first step depicted in operational flowchart 200 includes leaving a target application (Step 202). A user can leave the target application in a variety of ways, such as, for example, by minimizing the target application window, closing an application interface, and/or closing out of the target application. In an embodiment, step 202 is triggered when a user closes out of the target application.

After the user leaves the target application, a determination can be made by program 124 (FIG. 1) as to whether a floating list already exists (Step 203). The floating list can include a history of applications used after the target application. The history can come from previous iterations of the present embodiment or any other source known in the art. The floating list may include the list of the applications used after the target application, where one or more of the applications have been assigned a likelihood value of being used after the target application during future user sessions. The likelihood value can come from Step 206 and 208, described below.

If a floating list already exists, the floating list may be displayed on the user interface (Step 205). Likelihood values may have been calculated during a previous iteration of the present embodiment at Step 206 and 208. If the floating list has likelihood values assigned to the applications, the applications may be displayed from highest to lowest likelihood of being opened after the target application (Step 205). If the floating list does not have likelihood values assigned to the applications, the likelihood values may be calculated before displaying the floating list on the user interface. If a floating list does not already exist, a floating list may be created and populated in Steps 204 and 206. One example of a situation where a floating list does not already exist may include, for example, the first iteration with a target application.

After displaying the floating list (Step 205), or returning a determination that a floating list does not already exist, program 124 can identify applications used after leaving the target application during the current user session. The identified applications can be added to the existing floating list or to a new floating list. Data regarding the identified applications can also be recorded, such as, for example, number of applications between the identified application and the target application (intervening applications), the time elapsed after leaving the target application and before opening the identified application, or any other data known in the art.

It should be noted, the present embodiment can be performed to any application on a computing device. Furthermore, it is possible to have a program running the operational flowchart 200 simultaneously for separate target applications. For example, if application 1 is the target application, when application 1 is closed the first application identified (Step 204) may be application 5; when application 5 is closed, application 5 can be the target application of a new target session running concurrent to the target session for application 1. If application 28 is opened after application 5, application 28 can be identified for application 1 and for application 5.

A likelihood value may be calculated for one or more of the applications identified during Step 204 and/or the history list (e.g., a previous floating list) (Step 206). The likelihood value can relate to the probability of an application being opened after the target application during a future user session. The likelihood value can be based on the factors, such as, for example, frequency of application being used after target application, number of intervening applications, time elapsed, or any other data known in the art. In an embodiment, a likelihood value is assigned to each application (e.g., applications with the highest likelihood of reoccurrence will have the highest likelihood value). If a floating list already existed (Step 203) and if the applications on the existing floating list have likelihood values, the new calculation (Step 206) can factor in the previous likelihood value with the new factors found after leaving the target application (Step 202). The combination of previous likelihood values from the previous floating list and the factors from the current session can be the bases for the dynamic nature of the present embodiment. In other words, during each iteration of the operational flowchart 200 (during each user session after leaving the target application) the list of applications likely to be used after the target application will be adjusted and displayed during future user sessions.

After the applications are identified as being used after leaving the target application (Step 204), and after assigning likelihood values to the applications (Step 206), the floating list can be populated with the applications that are likely to be used after the target application (Step 208). In an embodiment, the application with the highest likelihood of reoccurrence can be the first application displayed on the user interface. Any number of likely applications can be displayed and may be adjusted by any means known in the art, such as, for example, user modification.

In an alternative embodiment, the calculation of likelihood (Step 206) and the creating of a floating list organized by likelihood value (Step 208) may be done before displaying the floating list on the user interface or at any other point of a user session.

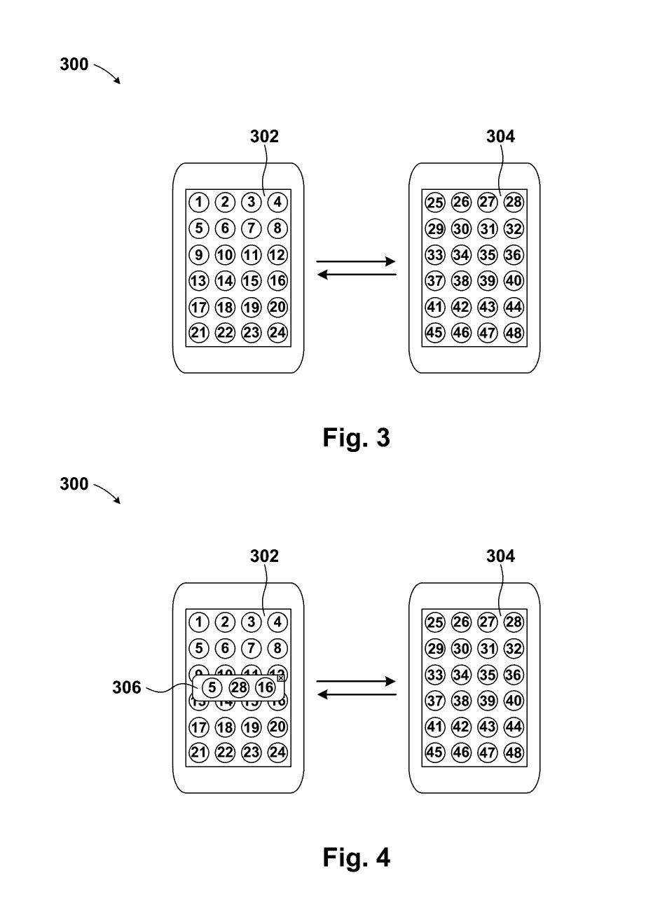

Referring now to FIGS. 3 and 4, the computing device 120 (FIG. 1) is depicted as a mobile device 300. The mobile device 300 may have application icons on one or more user interface screens. The organization and location of the application icons may be preset by a manufacturer or third party to achieve, for example, a desired look or functionality. Alternatively, the application icons may be rearranged by a user to achieve a different desired look or functionality. Typically, an application icon location is static; in other words, the icon remains in a set position until a user moves the icon to a new position. The present embodiment describes a method of using the dynamic tidy to organize applications as described with reference to FIG. 2.

In an embodiment, mobile device 300 may have application icons 1-24 displayed on a first user interface 302 and application icons 25-48 displayed on a second user interface 304. Application icons 1-48 may have preset locations, user defined locations, or locations set by another method known in the art. In an embodiment, application 1 is the target application and application icon 1 is located at the top left of the first user interface 302. The application icon 1 is next to application icon 2 and above application icon 5. It should be noted, applications 2 and 5 may not be used immediately after application 1. Operational flowchart 200 may be used to determine the applications likely to be used after closing application 1 by, for example, displaying the likely application icons (the floating list) on a floating layer 306 on the first user interface 302.

As described above, the first time a user leaves application 1, a floating list may not exist, such that no floating layer is displayed (FIG. 3). If a floating list does exist after leaving application 1, the floating list may be displayed on floating layer 306. The floating layer 306 may display any number of applications using any method known in the art, such as, for example, a display window or notification bar.

In an embodiment, application 1 is the target application. The first time the user closes application 1, a floating layer does not yet exist and the floating layer is not displayed on the user interface (FIG. 3). Subsequent to closing application 1, the following applications are opened in the following order: application 5, application, 28, and application 16. The floating list is now populated with three applications and the likelihood of reoccurrence may be calculated for each of the three applications. Using the factors described in reference to Step 206 above, application 5 might have the highest likelihood of being opened immediately after application 1, followed by application 28 and application 16. The next time the user closes application 1, the floating list may be displayed listing application 5, application 28, and application 16, respectively.

It may be common practice for users of mobile phones or devices to organize their applications by favorites or by genre, for example, shopping and utilities may be on one screen while social media and event applications may be on a different screen. However, users may not use the applications in the order arraigned on the multiple user screens. A dynamic floating list created for each application can enhance the user experience by saving user time spent searching their mobile device for applications after closing a specific application. Such that, after application 1 is closed, applications 5, 28, and 16 may be displayed on a floating layer because they are likely to be the next applications used based on previously gathered data during previous user sessions for application 1.

Referring now to FIG. 5, a block diagram of internal and external components of computers described above is provided, according to an exemplary embodiment. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 502, 504 is representative of any electronic device capable of executing machine-readable program instructions. Data processing system 502, 504 may be representative of a smart phone, a computer system, PDA, or other electronic devices. Examples of computing systems, environments, and/or configurations that may represented by data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Computing device 120 (FIG. 1) and server 110 (FIG. 1) may include respective sets of internal components 502a,b and external components 504a,b illustrated in FIG. 5. Each of the sets of internal components 502 include one or more processors 520, one or more computer-readable RAMs 522 and one or more computer-readable ROMs 524 on one or more buses 526, and one or more operating systems 528 and one or more computer-readable tangible storage devices 530. The one or more operating systems 528 and the Software Program 124 (FIG. 1) are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502a,b also includes a R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the program 124 (FIG. 1), can be stored on one or more of the respective portable computer-readable tangible storage devices 538, read via the respective R/W drive or interface 532 and loaded into the respective hard drive 530.

Each set of internal components 502a,b also includes network adapters or interfaces 536 such as a TCP/IP adapter cards, wireless Wi-Fi interface cards, or 3G or 4G wireless interface cards or other wired or wireless communication links. The program 124 (FIG. 1) can be downloaded to computing device 120 (FIG. 1) and server 110 (FIG. 1) from an external computer via a network (for example, the Internet, a local area network or other, wide area network) and respective network adapters or interfaces 536. From the network adapters or interfaces 536, the program 124 is loaded into the hard drive 530. The network may comprise copper wires, optical fibers, wireless transmission, routers, firewalls, switches, gateway computers and/or edge servers.

Each of the sets of external components 504a,b can include a computer display monitor 544, a keyboard 542, and a computer mouse 534. External components 504a,b can also include touch screens, virtual keyboards, touch pads, pointing devices, and other human interface devices. Each of the sets of internal components 502a,b also includes device drivers 540 to interface to computer display monitor 544, keyboard 542 and computer mouse 534. The device drivers 540, R/W drive or interface 532 and network adapter or interface 536 comprise hardware and software (stored in storage device 530 and/or ROM 524).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

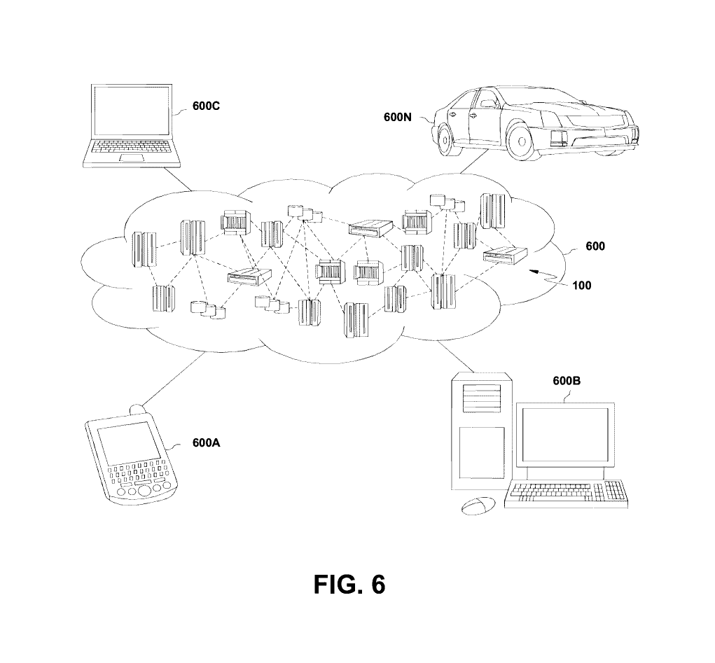

Referring now to FIG. 6, illustrative cloud computing environment 600 is depicted. As shown, cloud computing environment 600 comprises one or more cloud computing nodes 100 with which local computing devices used by cloud consumers, such as, for example, personal digital assistant (PDA) or cellular telephone 600A, desktop computer 600B, laptop computer 600C, and/or automobile computer system 600N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 600A-N shown in FIG. 6 are intended to be illustrative only and that computing nodes 100 and cloud computing environment 600 can communicate with any type of computerized device over any type of network and/or network addressable connection (e.g., using a web browser).

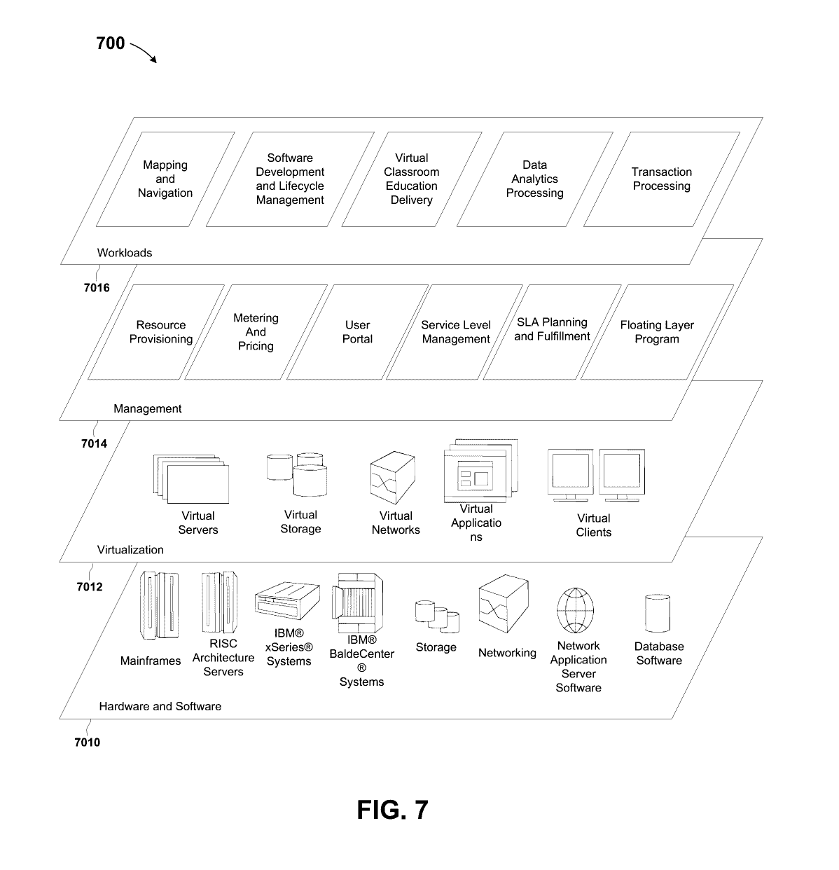

Referring now to FIG. 7, a set of functional abstraction layers 700 provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 7010 includes hardware and software components. Examples of hardware components include: mainframes; RISC (Reduced Instruction Set Computer) architecture based servers; storage devices; networks and networking components. In some embodiments, software components include network application server software.

Virtualization layer 7012 provides an abstraction layer from which the following examples of virtual entities may be provided: virtual servers; virtual storage; virtual networks, including virtual private networks; virtual applications and operating systems; and virtual clients.

In one example, management layer 7014 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators.

Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. A Floating Layer Program may allow an authorized user to initiate a target session to populate a dynamic floating list of correlating applications.

Workloads layer 7016 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for displaying application icons on a mobile device, the method comprising:
exiting a target application, wherein the target application is represented by a target icon residing on a first mobile screen and a second application is represented by a second icon residing on a second mobile screen;
determining the existence of a floating list after exiting the target application, wherein the floating list includes applications having likelihood values;
displaying the applications from the floating list on the first mobile screen as a floating layer, in response to the existence of the floating list, the applications are displayed in descending order of likelihood values, wherein the second application has a likelihood value, the second application is represented as a second floating icon displayed on the floating layer in addition to the second icon being displayed on the second mobile screen;
identifying applications used after exiting the target application;
assigning likelihood values to the applications used after exiting the target application, wherein the likelihood values depend on at least the number of intervening applications opened between the application and the target application; and
updating the floating list to include the applications with likelihood values used after exiting the target application.
